(19) United States
(12) Patent Application Publication
(10) Pub. No.: US 2007/0139010 A1
(43) Pub. Date: Jun. 21, 2007

(54) Systems and methods for charging a battery

(75) Inventors: William John Bonneau, East Troy, WI (US); Sherrill Gene Thomas, Chatham, VA (US); Brian Nedward Meyer, Fairview, PA (US)

Correspondence Address: PATRICK W. RASCHE (12552), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/312,224

(22) Filed: Dec. 20, 2005

(51) Int. Cl. H02J 7/00

(52) U.S. Cl. 320/125

(57) ABSTRACT

A system for charging a battery is described. The system includes a direct current (DC) power source configured to supply a DC power source output signal, a converter configured to convert the DC power source output signal into a converter output signal, a battery coupled to the converter and having a plurality of terminals, and a controller configured to receive a measure of a terminal charge across the terminals and configured to adjust a power that charges the battery based on the terminal charge.

### BACKGROUND OF THE INVENTION

This invention relates generally to power systems and more particularly to systems and systems and methods for charging a battery.

A fuel cell system offers significant efficiency and environmental benefits to traditional methods of electricity generation. The fuel cell system often complies with existing distribution standards followed by a plurality of distribution channels that distribute power from the fuel cell system. The compliance burdens the fuel cell system with an inverter, a line conditioner, and a stand-alone battery charger. The inverter, line conditioner, and stand-alone battery charger also add costs to the fuel cell system.

Most electric vehicles with batteries are charged. Thus, nearly all electric vehicles use some sort of the stand-alone battery charger. The stand-alone battery charger is most often connected to the power grid, and is therefore susceptible to lightning strikes that are common place at locations, such as golf courses equipped with golf carts.

### BRIEF DESCRIPTION OF THE INVENTION

In one aspect, a system for charging a battery is described. The system includes a direct current (DC) power source configured to supply a DC power source output signal, a converter configured to convert the DC power source output signal into a converter output signal, a battery coupled to the converter and having a plurality of terminals, and a controller configured to receive a measure of a terminal charge across the terminals and configured to adjust a power that charges the battery based on the terminal charge.

In another aspect, a system for charging battery is described. The system includes a motor, a direct current (DC) power source configured to supply a DC power source output signal, a converter configured to convert the DC power source output signal into a converter output signal, a battery coupled to the converter and the motor, and having a plurality of terminals, and a controller configured to receive a measure of a terminal charge across the terminals and configured to adjust a power that charges the battery based on the terminal charge.

In yet another aspect, a system for charging a battery is described. The system includes a direct current (DC) power source configured to output a DC power source output signal, a converter configured to convert the DC power source output signal into a converter output signal, and a plurality of electric vehicles. Each of the electric vehicles include a battery coupled to the converter and having a plurality of terminals, and a controller configured to receive a measure of a terminal charge across the terminals and configured to adjust a power that charges the battery based on the terminal charge.

In still another aspect, a method for charging a battery is described. The method includes receiving a direct current (DC) power source output signal from a DC power source, generating, by a converter, a converter output signal by converting the DC power source output signal, coupling a battery having a plurality of terminals to the converter, receiving, by a controller, a measure of a terminal charge across the terminals, and controlling, by the controller, a power supplied to the battery by adjusting the power based on the terminal charge.

### BRIEF DESCRIPTION OF THE DRAWINGS

FIG. 1 is a block diagram of an embodiment of a system for charging a battery.

FIG. 2 is a flowchart of an embodiment of a method for charging a battery.

FIG. 3 is a continuation of the flowchart of FIG. 2,

FIG. 4 is a circuit diagram of an embodiment of a direct current-to-direct current (DC-DC) converter that may be implemented within the system of FIG. 1.

FIG. 5 is a circuit diagram of an embodiment of an n-type metal oxide semiconductor field effect transistor, which may be implemented within the system of FIG. 1.

FIG. 6 is a block diagram of an embodiment of a vehicle in which system for charging a battery is implemented.

### DETAILED DESCRIPTION OF THE INVENTION

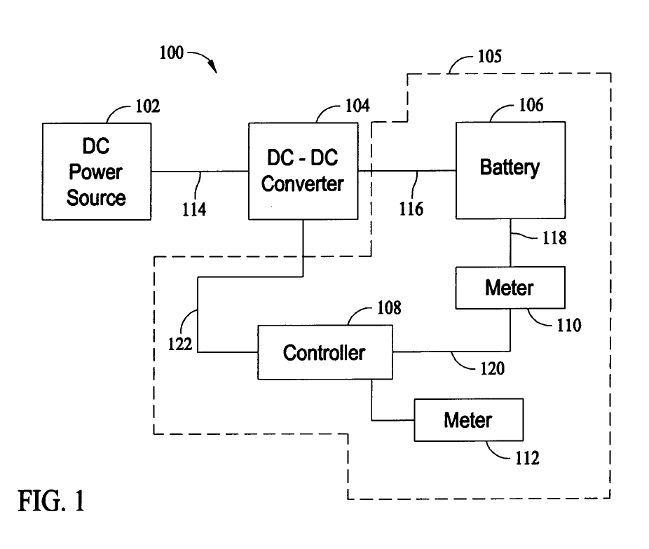

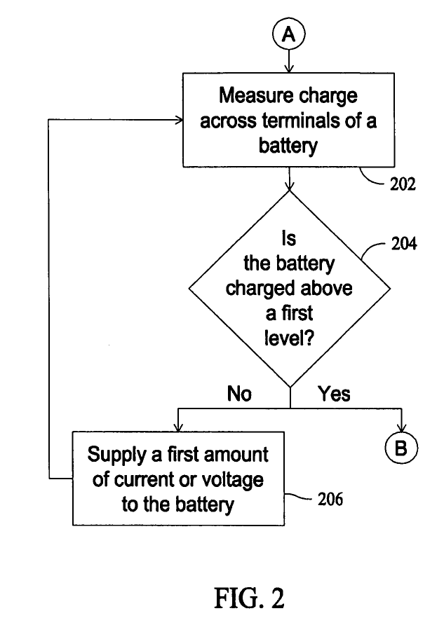

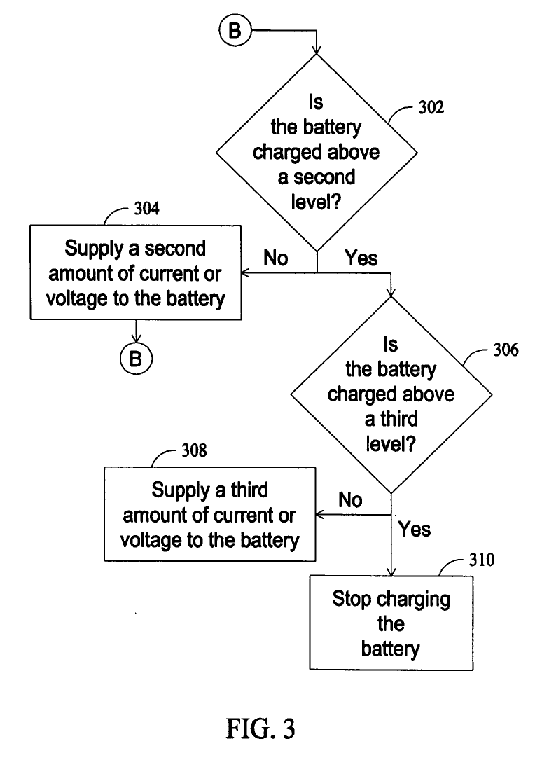

FIG. 1 is a block diagram of an embodiment of a system 100 for charging a battery and FIGS. 2 and 3 are a flowchart of an embodiment of a method for charging a battery. System 100 includes a direct current (DC) power source 102, a DC-to-DC (DC-DC) converter 104, and a system 105. System 105 includes a battery 106, a controller 108, a meter 110, and a memory device 112. Examples of DC power source 102 include a fuel cell stack and a solar cell. The fuel cell stack includes at least one fuel cell and is implemented as a stack of fuel cells, such as methanol fuel cells, ethanol fuel cells, and carbonaceous fuel cells. Memory device 112 can be a volatile memory or a non-volatile memory. An example of the volatile memory includes a dynamic RAM (DRAM) and a static RAM. Examples of the non-volatile memory include an Electrically Erasable Programmable Read Only Memory (EEPROM), a flash memory, a ferroelectric RAM (FRAM), and a magnetic RAM (MRAM). In an alternative embodiment, system 100 may not include memory device 112 and/or meter 110. Controller 108 is coupled to battery 108 if system 100 does not include meter 110. Battery 106 is a re-chargeable battery and examples of battery 106 include a lead-acid battery, a nickel-based battery, and a lithium-based battery. Meter 110 may be a voltmeter or an ammeter. As used herein, the term controller is not limited to just those integrated circuits referred to in the art as a controller, but broadly refers to a processor, a microprocessor, a microcontroller, a microcomputer, a programmable logic controller (PLC), an application specific integrated circuit, and any other programmable circuit. DC-DC converter 104 can be a stand-alone unit or alternatively is integrated within controller.

DC power source 102 supplies a DC power source output signal 114 having a DC power source output voltage. DC-DC converter 104 receives DC power source output signal 114 and converts DC power source output signal 114 into a DC-DC converter output signal 116 having a DC-DC converter output voltage. The DC-DC converter output voltage is a DC voltage has an amplitude that is different, such as higher or lower, than an amplitude of the DC power source output voltage. Alternatively, the DC-DC converter output voltage has the same amplitude as that of the DC power source output voltage. DC-DC converter output signal 116 is supplied to battery 106 for charging battery 106. Upon receiving, DC-DC converter output signal 116, battery 106 generates a battery output signal 118 across a plurality of terminals, such as an anode and a cathode, of battery 106. Meter 110 receives battery output signal 118 and measures 202 a charge, such as a voltage or a current, across the terminals of battery 106 to generate a meter output signal 120. The current across the terminals of battery 106 is measured by coupling a Hall effect device, a resistor, such as a resistive shunt, or any other current measuring device between the terminals. In an alternative embodiment that excludes meter 110, controller receives battery output signal 118 and measures the charge across the terminals of battery 106.

Controller 108 receives meter output signal 120, which indicates a parameter level, such as the voltage across the terminals of battery 106 or current between the terminals of battery 106. Upon reception of meter output signal 120, controller 108 determines 204 whether the parameter level is above a first level. Upon determining 204 that the parameter level is not above the first level, controller 108 generates a controller output signal 122 that signals DC-DC converter 104 to change DC power source output signal 114 to a first amount of current or voltage. The first amount of current or voltage is supplied 206 to battery 106 as DC-DC converter output signal 116. On the other hand, upon determining 204 that the parameter level is above the first level, controller 108 determines 302 whether the parameter level is above a second level higher than the first level. When controller 108 determines 302 that the parameter level is not above the second level, controller 108 generates controller output signal 122 that commands DC-DC converter 104 to adjust DC power source output signal 114 to a second amount of current or voltage. The second amount of current or voltage is supplied 304 to battery 106 in the form of DC-DC converter output signal 116. Otherwise, upon determining 302 that the parameter level is above the second level, controller 108 determines 306 whether the parameter level is above a third level higher than the second level. When controller 108 determines 306 that the parameter level is not above the third level, controller 108 generates controller output signal 122 that commands DC-DC converter 104 to adjust DC power source output signal 114 to a third amount of voltage or current, such as a trickle. The third amount of current or voltage is supplied 308 to battery 106 as DC-DC converter output signal 116. Otherwise, upon determining 306 that the parameter level is above the third level, controller 108 generates controller output signal 122 that commands DC-DC converter 104 to adjust DC power source output signal 114 to a zero current or voltage. DC-DC converter 104 stops 310 charging battery 106 when DC-DC converter 104 outputs the zero current or voltage.

Each of the first, second, and third levels depends on a type of battery 106. For example, if battery 106 is a 48 volt (V) battery formed by connecting a plurality of 12 V batteries in series, the first level ranges from and including 45 volts to 58 volts, the second level ranges from and including four amperes to 15 amperes, and the third level ranges from and including 57 volts to 69 volts. Moreover, if battery 106 is a 48 V battery formed by connecting a plurality of 12 V batteries in series, the first amount of current is 15 amperes, the second amount of voltage is 57 volts, and the third amount of current is four amperes.

In an alternative embodiment, the method for charging a battery is implemented by applying more or less than two levels. For example, the method may be implemented using the first level, the second level, the third level, and a fourth level. In the alternative embodiment, controller 108 determines 306 whether the parameter level is above the third level upon determining 302 that the parameter level is above the second level. Upon determining that the parameter level is not above the third level, the third amount of current or voltage is supplied 308 to battery. On the other hand, upon determining that the parameter level is not above a fourth level but above the third level, a fourth amount of current or voltage is supplied by DC-DC converter 104 to battery. The fourth level is greater than the third level. Upon determining that the parameter level is above the fourth level, a zero current or voltage is supplied by DC-DC converter 104 to battery 106.

Controller 108 stores within memory device 112 a charging history, such as the first, second, and third levels, the first, second, and third amounts of currents of a plurality of batteries used to drive a plurality of different electric vehicles. For example, controller 108 stores within memory device 112 the charging history of battery 106, such as a 48 volt battery formed from a series of 12 volt batteries, and the charging history of a 6 volt battery. Moreover, controller 108 stores within memory device 112 a plurality of operating voltages of a plurality of batteries used to drive a plurality of different electric vehicles. For example, controller 108 stores within memory device 112 that battery 106 is a 12 V battery used in an electric vehicle and stores that another battery 106 is a 6 V battery used to drive another electric vehicle.

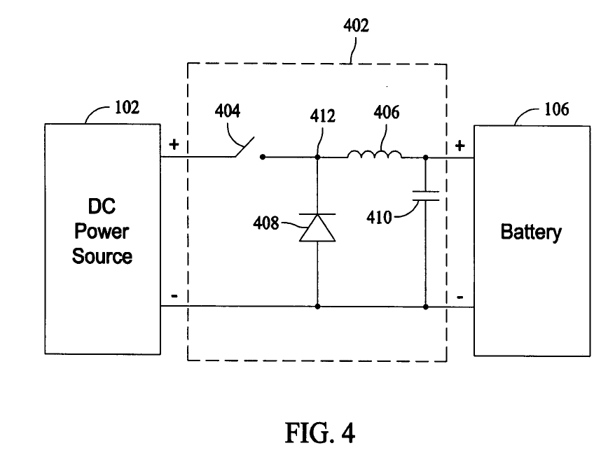

FIG. 4 is a circuit diagram of an embodiment of a DC-DC converter 402, which is an exemplary embodiment of DC-DC converter 104 (FIG. 1). DC-DC converter 402 includes a switch 404, such as a semiconductor switch, an inductor 406, a diode 408, and a capacitor 410.

Controller 108 operates switch 404 according to the PWM cycles, such as a first PWM cycle, a second PWM cycle, and a third PWM cycle. When controller 108 determines 204 (FIG. 2) that the parameter level is not above the first level, controller 108 operates, such as opens and closes, switch 404 at the first PWM cycle. DC-DC converter 402 supplies 206 (FIG. 2) the first amount of current or voltage to battery 106 when switch 404 operates at the first PWM cycle.

Upon determining 302 (FIG. 3) that the parameter level is above the first level but not above the second level, controller 108 operates switch 404 at the second PWM cycle. DC-DC converter 402 supplies 304 the second amount of current or voltage to battery 106 when switch 404 operates at the second PWM cycle. Further, upon determining 306 (FIG. 3) that the parameter level is above the second level but not above the third level, controller 108 operates switch 404 at the third PWM cycle. DC-DC converter 402 supplies 308 (FIG. 3) the third amount of current or voltage to battery 106 when switch 404 operates at the third PWM cycle. Moreover, upon determining 306 (FIG. 3) that the parameter level is above the third level, controller 108 opens switch 404. DC-DC converter 402 supplies a zero current or voltage to battery 106 when switch 404 is open.

An example of the first PWM cycle for charging a 48 V battery 106 formed by a series of 12 V batteries includes a cycle having an on time from and including 0 to 85%. Moreover, an example of the second PWM cycle for charging 48 V battery 106 formed by a series of 12 V batteries includes a cycle having an on time from and including 85% to 90%. Furthermore, an example of the third PWM cycle for charging 48 V battery 106 formed by a series of 12 V batteries includes a cycle having an on time from and including 85% to 100%.

The cathode of DC power source 102 is coupled to the cathode of battery 106 and the anode of DC power source 102 is coupled via switch 404 and inductor 406 to the anode of battery 106. When switch 404 is closed, DC power source output signal 114 (FIG. 1) flows from the cathode of DC power source 102 via the cathode and anode of battery 106 and inductor 406 to the anode of battery 106. When switch 404 is open, DC power source output signal 114 (FIG. 1) does not flow to the anode of DC power source 102. In an alternative embodiment, capacitor 410 may not be included within DC-DC converter 402. Capacitor 410 acts as a filter that smoothes transitions between the opening and closing of switch 404.

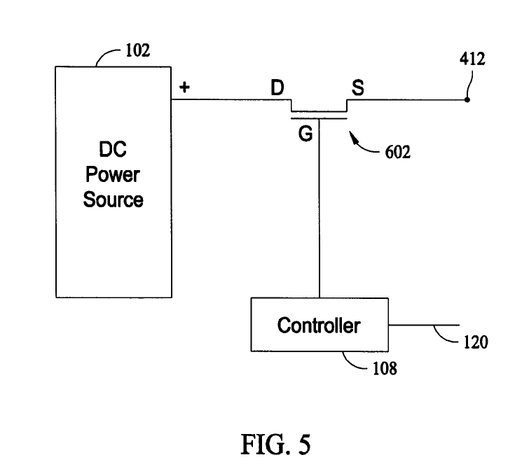

FIG. 5 is a circuit diagram of an embodiment of an n-type metal oxide semiconductor field 602 effect transistor (MOSFET), which is an exemplary embodiment of switch 404 (FIG. 4). Other examples of switch 404 (FIG. 4) include a p-type MOSFET, a junction FET (JFET), and a bipolar junction transistor (BJT). Controller 108 is coupled to a gate (G) of n-type MOSFET 602. A drain (D) of n-type MOSFET 602 is coupled to the anode of DC power source 102 and a source of n-type MOSFET 602 is coupled to terminal 412. Controller 108 opens switch 404 by reducing a gate voltage at the gate to below a threshold of n-type MOSFET 602. When the gate voltage is below the threshold, a source-to-drain current does not flow from the source to the drain and switch 404 is open. On the other hand, when the gate voltage is not below the threshold, the source-to-drain current flows from the source to the drain and switch 404 is closed.

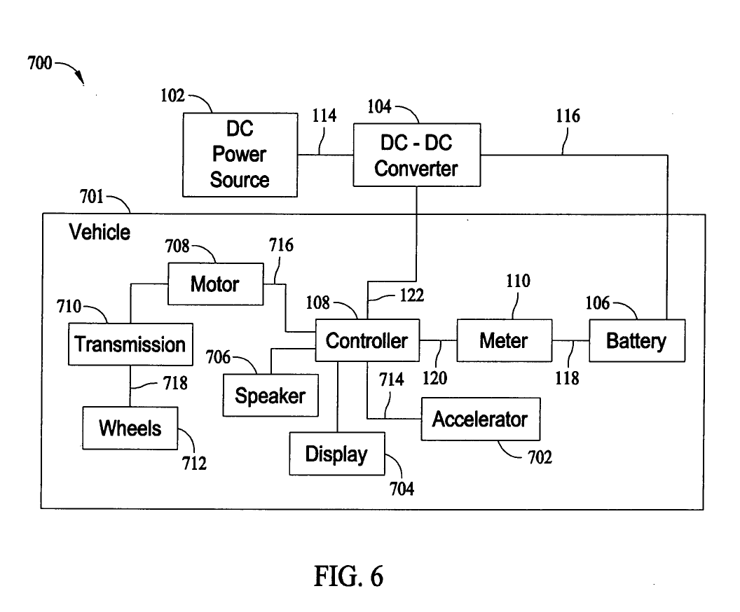

FIG. 6 is a block diagram of an embodiment of a system 700. System 700 includes a vehicle 701, DC power source 102, and DC-DC converter 104. Examples of vehicle 701 include an electric vehicle, such as an electric golf cart, an electric car, and an electric truck, driven by battery 106 and not fuel. Vehicle 701 includes battery 106, controller 108,; meter 110, an accelerator 702, a display 704, a speaker 706, a motor 708, a transmission 710, and a plurality of wheels 712. In an alternative embodiment, vehicle 701 includes DC-DC converter 104. In another alternative embodiment, vehicle 701 does not include meter 110. Vehicle 701 may include more than one speaker and more than one display. Examples of display 704 include a digital display, an analog display, and a light emitting diode. Transmission 710 may be a gear system including at least two gears.

When battery 106 is charged by DC power source 102 to above the first level, battery 106 activates at least one of motor 708, display 704, and speaker 706. Controller 108 controls an amount of charge provided from battery 106 to at least one of motor 708, speaker 706, and display 704. For example, controller 108 brightens display 704 by increasing an amount of charge provided by battery 106 to display 704. As another example, controller 108 dims display 704 by decreasing an amount of charge provided by battery 106 to display 704.

When motor 708 is activated and an operator accelerates vehicle 701, accelerator 702 outputs a velocity and/or a torque to generate an accelerator output signal 714. Controller 108 receives accelerator output signal 714 and generates a controller output signal 716 that is supplied to drive motor 708. Motor 708 rotates at the velocity and/or torque upon receiving controller output signal 716. Motor 708 rotates at the velocity and/or torque to control transmission 710. Transmission 710 adjusts the velocity and/or a torque into a faster or alternatively a slower velocity and/or a torque to generate a transmission output. Transmission 710 is coupled to wheels 712 via at least one shaft 718 and wheels 712 rotate upon receiving the transmission output.

In an alternative embodiment, a plurality of vehicles, such as vehicle 701, are coupled to the same DC power source 102 via a plurality of DC-DC power converters, such as DC-DC power converter 104. For example, a first vehicle, such as vehicle 701, is coupled to DC-DC power source 102 via a first DC-DC power converter and a second vehicle, such as vehicle 701, is coupled to DC-DC power source 102 via a second DC-DC power converter.

System 100 (FIG. 1) does not include a direct current-to-alternating current (DC-AC) inverter that converts DC power source output signal 114 output by the fuel cell stack. The DC-AC inverter inverts DC power source output signal 114 from the fuel stack from DC to AC to generate a DC-AC inverter output signal that is supplied to charge battery 106. Moreover, system 100 (FIG. 1) does not include a line conditioning circuit that conditions the DC-AC inverter output signal to generate a line conditioning circuit output signal. The line conditioning circuit output signal is supplied to battery 106. Examples of the line conditioning circuit include a circuit that increases an amplitude of the DC-AC inverter output signal or reduces noise within the DC-AC inverter output signal. The line conditioning circuit is used when the fuel cell stack is coupled to a power grid that is operated by a utility company and that supplies an AC power grid output signal over an AC line. The AC power grid output signal is supplied to the fuel cell stack via the AC line. The connection of the AC line to the fuel cell stack results in a use of the line conditioning circuit that conditions the DC-AC inverter output signal to abide by a plurality of distribution standards, such as voltage and frequency standards. The line conditioning circuit and the DC-AC inverter additional costs.

An alternative manner of charging battery 106 is by coupling battery 106 to the AC line via a battery charger and an AC-DC converter. The battery charger may include a rectifier that inverts the AC power grid output signal into a DC battery charger output signal that is supplied to DC-DC converter 104. The rectifier may not be included within the battery charger and may be a separate unit. The battery charger and the rectifier add costs. Moreover, the battery charger is usually mounted on a shelf. The mounting may result in the battery charger falling on a floor to create safety concerns. Moreover, the fall may also create cost concerns due to damage to the battery charger. System 100 (FIG. 1) does not include the battery charger and the rectifier.

Technical effects of the herein described systems and methods for charging a battery include reducing costs by not including the DC-AC inverter, the line conditioning circuit, the battery charger, and the rectifier within system 100 (FIG. 1). Other technical effects include cost per kilowatt savings in comparison to a cost of using power from the power grid. Yet further technical effects include eliminating an effect of a failure of the AC line on the fuel cell stack and an effect of a lightning strike on the fuel cell stack via the AC line. The lightning strike can cause damage to the fuel cell stack or to the battery charger. System 100 (FIG. 1) including DC power source 102 is independent of the AC line and therefore, is not affected by the lightning strike. Further technical effects include implementing the same system 100 to charge battery 106 within a plurality of electric vehicles. For example, system 100 is used to charge a 36 V battery used in an electric vehicle and also to charge a 48 V battery used in another electric vehicle. Each of the electric vehicles are the same as vehicle 701. Moreover, use of the fuel cell stack to charge battery 106 and use of battery 106 to drive an electric vehicle may be more environmentally friendly than using fuel to drive a vehicle. Other technical effects include charging battery 106 at a plurality of levels by supplying a plurality of amounts of currents to battery 106 based on battery output signal 118.

While the invention has been described in terms of various specific embodiments, those skilled in the art will recognize that the invention can be practiced with modification within the spirit and scope of the claims.

What is claimed is:

1. A system for charging a battery, said system comprising:
a direct current (DC) power source configured to supply a DC power source output signal;
a converter configured to convert the DC power source output signal into a converter output signal;
a battery coupled to said converter and having a plurality of terminals; and
a controller configured to receive a measure of a terminal charge across said terminals and configured to adjust a power that charges said battery based on the terminal charge.

2. A system in accordance with claim 1, wherein said DC power source comprises one of a fuel cell and a solar cell.

3. A system in accordance with claim 1, wherein said converter comprises a DC-to-DC converter.

4. A system in accordance with claim 1, wherein said controller is located within a vehicle.

5. A system in accordance with claim 1, wherein said controller comprises a processor configured to control a motor of a vehicle based on a signal received from an accelerator.

6. A system in accordance with claim 1 further comprising a meter configured to measure a voltage across said terminals.

7. A system in accordance with claim 1, wherein said converter comprises a switch configured to open and close, and said controller configured to control the opening and closing of said switch according to a pulse width modulation cycle upon determining that the terminal charge is below a level.

8. A system in accordance with claim 1, wherein said converter comprises a switch configured to open and close, and said controller configured to:
open and close said switch according to a first pulse width modulation cycle upon determining that the terminal charge is below a first level; and
open and close said switch according to a second pulse width modulation cycle upon determining that the terminal charge is at above the first level and below a second level.

9. A system in accordance with claim 1, wherein said converter comprises a switch configured to open and close, and said controller configured to:
open and close said switch according to a first pulse width modulation cycle upon determining that the terminal charge is below a first level;
open and close said switch according to a second pulse width modulation cycle upon determining that the terminal charge is at above the first level and below a second level; and
open and close said switch according to a third pulse width modulation cycle upon determining that the terminal charge is above the second level and below a third level.

10. A system for charging battery, said system comprising:
a motor;
a direct current (DC) power source configured to supply a DC power source output signal;
a converter configured to convert the DC power source output signal into a converter output signal;
a battery coupled to said converter and said motor, and having a plurality of terminals; and
a controller configured to receive a measure of a terminal charge across said terminals and configured to adjust a power that charges said battery based on the terminal charge.

11. A system in accordance with claim 10, wherein said DC power source comprises one of a fuel cell and a solar cell.

12. A system in accordance with claim 10, wherein said converter comprises a DC-to-DC converter.

13. A system in accordance with claim 10, wherein said controller is located within an electric vehicle.

14. A system in accordance with claim 10, wherein said controller comprises a processor configured to control a motor of a vehicle based on a signal received from an accelerator.

15. A system in accordance with claim 10 further comprising a meter configured to measure a voltage across said terminals.

16. A system in accordance with claim 10, wherein said converter comprises a switch configured to open and close, and said controller configured to adjust the opening and closing of said switch according to a pulse width modulation cycle upon determining that the terminal charge is below a level.

17. A system in accordance with claim 10, wherein said converter comprises a switch configured to open and close, and said controller configured to:
adjust the opening and closing of said switch according to a first pulse width modulation cycle upon determining that the terminal charge is below a first level; and
open and close said switch according to a second pulse width modulation cycle upon determining that the terminal charge is above the first level and below a second level.

18. A system for charging a battery, said system comprising:
a direct current (DC) power source configured to output a DC power source output signal;
a converter configured to convert the DC power source output signal into a converter output signal;
a plurality of electric vehicles, wherein each of said electric vehicles comprise:
a battery coupled to said converter and having a plurality of terminals; and
a controller configured to receive a measure of a terminal charge across said terminals and configured to adjust a power that charges said battery based on the terminal charge.

19. A system in accordance with claim 18, wherein said DC power source comprises one of a fuel cell and a solar cell.

20. A system in accordance with claim 18, wherein said converter comprises a DC-to-DC converter.

21. A system in accordance with claim 18, wherein said controller comprises a processor configured to control a motor of a vehicle based on a signal received from an accelerator.

22. A system in accordance with claim 18 further comprising a meter configured to measure a voltage across said terminals.

23. A system in accordance with claim 18, wherein said converter comprises a switch configured to open and close, and said controller configured to adjust the opening and closing of said switch according to a pulse width modulation cycle upon determining that the terminal charge is below a level.

24. A method for charging a battery, said method comprising:
receiving a direct current (DC) power source output signal from a DC power source;
generating, by a converter, a converter output signal by converting the DC power source output signal;
coupling a battery having a plurality of terminals to the converter;
receiving, by a controller, a measure of a terminal charge across the terminals; and
controlling, by the controller, a power supplied to the battery by adjusting the power based on the terminal charge.

25. A method in accordance with claim 24, wherein said receiving the DC power source output signal comprises receiving the DC power source output signal from one of a fuel cell and a solar cell.

26. A method in accordance with claim 24, wherein said generating, by the converter, the converter output signal comprises generating, by a DC-to-DC converter, the converter output signal.

27. A method in accordance with claim 24, further comprising implementing the controller within an electric vehicle.

28. A method in accordance with claim 24 further comprising controlling, by the controller, a motor of a vehicle based on a signal received from an accelerator.
